(19) United States
(12) Patent Application Publication
(10) Pub. No.: US 2021/0054533 A1
(43) Pub. Date: Feb. 25, 2021

(54) DARK-COLORED AND INFRARED-REFLECTIVE FIBER WITHOUT METAL COMPOSITION, MANUFACTURING METHOD THEREOF, AND TEXTILE

(71) Applicant: NAN YA PLASTICS CORPORATION, Taipei (TW)

(72) Inventors: TE-CHAO LIAO, TAIPEI (TW); SEN-HUANG HSU, TAIPEI (TW); CHUN-HAO FANG, TAIPEI (TW)

(21) Appl. No.: 16/829,147

(22) Filed: Mar. 25, 2020

(30) Foreign Application Priority Data
Aug. 21, 2019 (TW) 108129811

(51) Int. Cl. D01F 1/06; D01D 5/08; C08K 5/00; D01F 6/62; C09B 37/00

(52) U.S. Cl. CPC D01F 1/06; D01D 5/08; D01F 1/10; D01F 6/62; C09B 37/00; C08K 5/0041

(57) ABSTRACT

A dark-colored and infrared-reflective fiber without metal composition, a manufacturing method thereof, and a dark-colored and infrared-reflective textile are provided. The dark-colored and infrared-reflective fiber includes a polymer resin material and an organic azo pigment. The organic azo pigment is dispersed in the polymer resin material in the form of a plurality of micro particles. The organic azo pigment has an average particle size between 0.2 micrometers and 4 micrometers and a heat-resistant temperature of not less than 300° C. The organic azo pigment has an infrared reflectance of not less than 50% in an infrared wavelength range between 780 nm and 2,500 nm.

### CROSS-REFERENCE TO RELATED PATENT APPLICATION

This application claims the benefit of priority to Taiwan Patent Application No. 108129811, filed on Aug. 21, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a dark-colored and infrared-reflective fiber, and more particularly to a dark-colored and infrared-reflective fiber without metal composition, a manufacturing method thereof, and a dark-colored and infrared-reflective textile.

### BACKGROUND OF THE DISCLOSURE

A conventional carbon black-added textile has a certain degree of blackness, but does not provide a heat insulation effect. When the carbon black-added textile is made into a cloth and worn by a user, the user will feel stifled when under sunlight.

To solve this problem, a dark-colored and thermal-insulation textile has appeared on the market. The dark-colored and thermal-insulation textile has a certain thermal-insulation effect and blackness. However, the dark-colored and thermal-insulation textile requires an addition of inorganic infrared reflective materials (i.e., inorganic heavy metal materials including iron, copper, nickel, cobalt, or chromium) and other dark pigments (i.e., black pigments) to achieve considerable blackness. Therefore, the commercially available dark-colored and thermal-insulation textile will result in adverse effects on the human body and the environment when in use or after being discarded.

### SUMMARY OF THE DISCLOSURE

In response to the above-referenced technical inadequacies, the present disclosure provides a dark-colored and infrared-reflective fiber without metal composition, a manufacturing method thereof, and a dark-colored and infrared-reflective textile.

In one aspect, the present disclosure provides a dark-colored and infrared-reflective fiber without metal composition. The fiber is formed by melt spinning, and the fiber includes a polymer resin material and an organic azo pigment. The organic azo pigment is formed by a diazo coupling reaction between a diazo component and a coupling component, and the organic azo pigment is dispersed in the polymer resin material in the form of a plurality of micro particles. The organic azo pigment has an average particle size between 0.2 micrometers and 4 micrometers and a heat-resistant temperature of not less than 300° C. The organic azo pigment has an infrared reflectance of not less than 50% in an infrared wavelength range between 780 nm and 2,500 nm.

In another aspect, the present disclosure provides a manufacturing method of a dark-colored and infrared-reflective fiber. The manufacturing method includes implementing a masterbatch forming step. The masterbatch forming step includes mixing a polymer resin material from 50 to 99.5 weight percent with an organic azo pigment from 0.5 to 50 weight percent under a temperature between 150° C. and 300° C. to form a plurality of thermal-insulation masterbatches. The manufacturing method further includes implementing a fiber forming step. The fiber forming step includes melt-spinning the plurality of thermal-insulation masterbatches under a temperature between 150° C. and 300° C. to form a plurality of dark-colored and infrared-reflective fibers. The organic azo pigment is formed by a diazo coupling reaction between a diazo component and a coupling component, and the organic azo pigment is dispersed in the polymer resin material in the form of a plurality of micro particles. The organic azo pigment has an average particle size between 0.2 micrometers and 4 micrometers and a heat-resistant temperature of not less than 300° C., and the organic azo pigment has an infrared reflectance of not less than 50% in an infrared wavelength range between 780 nm and 2,500 nm. In addition, an L value of each of the fibers in a CIELAB color space is not greater than 15.

In yet another aspect, the present disclosure provides a textile that is formed by interlacing a plurality of dark-colored and infrared-reflective fibers. The textile has a thickness between 500 micrometers and 1,500 micrometers, and each of the dark-colored and infrared-reflective fibers includes a polymer resin material and an organic azo pigment. The organic azo pigment is formed by a diazo coupling reaction between a diazo component and a coupling component. The organic azo pigment is dispersed in the polymer resin material in the form of a plurality of micro particles. The organic azo pigment has an average particle size between 0.2 micrometers and 4 micrometers and a heat-resistant temperature of not less than 300° C. The organic azo pigment has an infrared reflectance of not less than 50% in an infrared wavelength range between 780 nm and 2,500 nm.

Therefore, the dark-colored and infrared-reflective fiber without metal composition, the manufacturing method thereof, and the textile can achieve an ideal dark-color and thermal-insulation effect, and can also have advantages of generating less toxic and therefore resulting in less harm to the environment through the technical features of “an organic azo pigment is formed by a diazo coupling reaction between a diazo component and a coupling component, and the organic azo pigment is dispersed in the polymer resin material in the form of a plurality of micro particles” and “the organic azo pigment has an average particle size between 0.2 micrometers and 4 micrometers and a heat-resistant temperature of not less than 300° C.; and the organic azo pigment has an infrared reflectance of not less than 50% in an infrared wavelength range between 780 nm and 2,500 nm” without adding any heavy metal composition or additional dark pigment.

Moreover, because the dark-colored and infrared-reflective textile of the present disclosure has the ideal thermal-insulation effect, a rise of temperature of the textile under sunlight can be effectively reduced. Therefore, when the dark-colored and infrared-reflective textile is made into a cloth and worn by a user, the user will not feel stifled when under sunlight.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a dark-colored and infrared-reflective fiber according to an embodiment of the present disclosure.

FIG. 2 is a flowchart of a manufacturing method of the dark-colored and infrared-reflective fiber according to the embodiment of the present disclosure.

FIG. 3 is a schematic view of a dark-colored and infrared-reflective textile according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

[Dark-Colored and Infrared-Reflective Fiber]

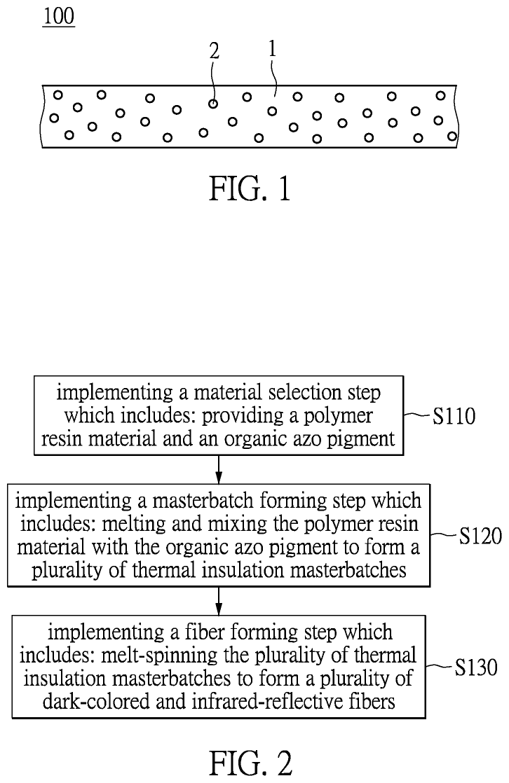

Referring to FIG. 1, the present embodiment discloses a dark-colored and infrared-reflective fiber 100 without metal composition. The dark-colored and infrared-reflective fiber 100 is formed by a melt spinning process.

Further, the dark-colored and infrared-reflective fiber 100 of the present embodiment can achieve an ideal dark-color and thermal-insulation effect, and can also have advantages of generating less toxics and therefore resulting in less harm to the environment without adding any heavy metal composition and additional dark pigment. The present embodiment can achieve the advantages by adding an organic azo pigment with specific functional groups and specific physical and chemical properties, and by the selection of a content range of each component.

In order to achieve the above-mentioned advantages, the dark-colored and infrared-reflective fiber 100 includes a polymer resin material 1 and an organic azo pigment 2 dispersed in the polymer resin material 1.

The main component of the dark-colored and infrared-reflective fiber 100 is the polymer resin material 1. That is, the polymer resin material 1 is a matrix component of the dark-colored and infrared-reflective fiber 100. In addition, in order to enable the fiber 100 to be adaptable to the melt spinning process, the polymer resin material 1 is preferably at least one material selected from the group consisting of a polyester (PET) resin, a polyolefin (PE) resin, a polyacrylonitrile (PAN) resin, and a polyamide (PA) resin, but the present disclosure is not limited thereto.

Moreover, the organic azo pigment 2 is dispersed in the polymer resin material 1 in the form of a plurality of micro particles.

In terms of specific functional groups, the organic azo pigment 2 is formed by a diazo coupling reaction between a specific diazo component and a specific coupling component, and a molecular structure of the organic azo pigment 2 has a plurality of chromophores which include an azo group and a methyl amine group.

The above-mentioned “diazo coupling reaction” refers to a reaction in which an aromatic diazo salt is coupled to an aromatic compound having a high charge density to form an azo compound.

In addition, the above-mentioned “specific coupling component” may be, for example, 3-(4-aminophenyl-imino)-1-oxo-4,5,6,7-tetrachloro-benzidine. The above-mentioned “specific diazo component” may be, for example, 3-oxobutyl amino residue compound, but the present disclosure is not limited thereto. Further, the above-mentioned “methyl amine” may also be referred to as methyl imino, and its chemical formula is H₃CHN═.

It is worth mentioning that since the molecular structure of the organic azo pigment 2 has the methyl amine group, the organic azo pigment 2 can absorb light in a visible region (e.g., visible light with a wavelength between 380 and 780 nm), and can reflect light in an infrared region (e.g., infrared light with a wavelength between 780 and 2,500 nm). Accordingly, the organic azo pigment 2 is a dark-colored azo pigment, and more preferably a black-colored azo pigment. The dark-colored and infrared-reflective fiber 10 can achieve the dark-color and thermal-insulation effect through an addition of the organic azo pigment 2.

In terms of physical and chemical properties, the plurality of micro particles of the organic azo pigment 2 has an average particle size between 0.2 micrometers (μm) and 4 micrometers, and a heat-resistant temperature of not less than 300° C. Further, the organic azo pigment 2 has an infrared reflectance of not less than 50% in an infrared wavelength range between 780 nm and 2,500 nm.

More specifically, in order to enable the organic azo pigment 2 to be uniformly dispersed in the polymer resin material 1 during a fiber manufacture process, the average particle size of the organic azo pigment 2 is preferably between 0.2 micrometers and 4 micrometers, and more preferably between 0.3 micrometers and 3 micrometers.

If the average particle size of the organic azo pigment 2 is greater than the upper limit of the above-mentioned particle size range, the organic azo pigment 2 may not be uniformly dispersed in the polymer resin material 1. Further, if the average particle size of the organic azo pigment 2 is too large, the fiber may not be formed smoothly during the fiber manufacture process due to screw slippage, or equipment of the process may be worn out.

Conversely, if the average particle size of the organic azo pigment 2 is smaller than the lower limit of the above-mentioned particle size range, the manufacturing cost of the fiber may be increased, and the organic azo pigment 2 may fail to enable the fiber to achieve expected effects, such as thermal-insulation effect.

In addition, in order to prevent the organic azo pigment 2 from cracking during the fiber manufacture process (especially during the melt spinning process) so as to maintain the characteristics of the organic azo pigment 2, the heat-resistant temperature of the organic azo pigment 2 is preferably not lower than 300° C., and more preferably not lower than 350° C.

Further, in order to enable the organic azo pigment 2 to provide excellent thermal-insulation effect in the fiber 100, the organic azo pigment 2 has an infrared reflectance of not less than 50%, and more preferably not less than 60% in an infrared wavelength range between 780 nm and 2,500 nm. That is, the organic azo pigment 2 can reflect infrared rays that may cause the temperature of a textile to increase, so as to create a thermal-insulation effect.

In terms of the content range of each component, based on the total weight of the dark-colored and infrared-reflective fiber 100 that is 100 wt %, a content range of the polymer resin material 1 is between 80 wt % and 99.5 wt %, and a content range of the organic azo pigment 2 is between 0.5 wt % and 20 wt %. Preferably, the content range of the polymer resin material 1 is between 90 wt % and 99.5 wt %, and the content range of the organic azo pigment 2 is between 0.5 wt % and 10 wt %. More preferably, the content range of the polymer resin material 1 is between 95 wt % and 99.5 wt %, and the content range of the organic azo pigment 2 is between 0.5 wt % and 5 wt %.

The dark-colored and infrared-reflective fiber 100 of the present embodiment can achieve an ideal dark-color and thermal-insulation effect, and can also have the advantages of environmental protection and low toxicity, without adding any heavy metal composition and additional dark pigment. The present embodiment can achieve the advantages by adding the organic azo pigment with specific functional groups and specific physical and chemical properties, and by the selection of the content range of each component.

If the content of the organic azo pigment 2 is greater than the upper limit of the above-mentioned content range, the fiber may not be formed smoothly during the fiber manufacture process due to screw slippage, or equipment of the process may be worn out. Conversely, if the content of the organic azo pigment 2 is lower than the lower limit of the above-mentioned content range, the dark-colored effect of the fiber may be insufficient (i.e., the blackness may be insufficient), and the infrared reflectance of the fiber may be insufficient. Therefore, the fiber cannot achieve the ideal dark-color and thermal-insulation effect.

According to the selections of materials and the adjustment of content range of each component, an L value of the dark-colored and infrared-reflective fiber 100 in a CIELAB color space is preferably not greater than 15, and more preferably not greater than 12. That is, the dark-colored and infrared-reflective fiber 100 can achieve sufficient blackness without adding additional dark pigments.

In addition, since the organic azo pigment 2 can provide the ideal dark-color and thermal-insulation effect to the fiber 100, the fiber 100 does not require any inorganic thermal-insulation material to be added therein. That is, in the present embodiment, the dark-colored and infrared-reflective fiber 100 does not include any metal composition such as chromium (Cr), manganese (Mn), iron (Fe), cobalt (Co), nickel (Ni), copper (Cu), zinc (Zn), silver (Ag), cadmium (Cd), gold (Au) or bismuth (Bi). Therefore, the dark-colored and infrared-reflective fiber 100 has the advantages of environmental protection and low toxicity.

In addition, since the polymer resin material 1 (i.e., PET, PE, PAN, etc.) and the organic azo pigment 2 are all organic materials, and have certain compatibility with each other, the dark-colored and infrared-reflective fiber 100 of the present embodiment does not include any non-reactive compatibilizer or reactive compatibilizer (e.g., styrene maleic anhydride (SMA), acrylic polymers, and epoxy polymers), but the present disclosure is not limited thereto.

It is worth mentioning that, in an embodiment of the present disclosure, the dark-colored and infrared-reflective fiber 100 may further include an antioxidant. Based on the total weight of the dark-colored and infrared-reflective fiber 100 (i.e., 100 wt %), a content range of the antioxidant is between 0.1 wt % and 1 wt %. The antioxidant may be, for example, a phenolic antioxidant, an amine antioxidant, a phosphorus antioxidant, or a thioester antioxidant. The antioxidant of the present embodiment is preferably a phenolic antioxidant, but the present disclosure is not limited thereto. Since an antioxidant is added to the dark-colored and infrared-reflective fiber 100, yellowing of the fiber can be effectively avoided.

[Manufacturing Method of Dark-Colored and Infrared-Reflective Fiber]

The above description relates to the dark-colored and infrared-reflective fiber 100. A manufacturing method of the dark-colored and infrared-reflective fiber 100 will be described below.

Referring to FIG. 2, the present embodiment also discloses the manufacturing method of the dark-colored and infrared-reflective fiber. The manufacturing method of the dark-colored and infrared-reflective fiber includes step 110, step 120, and step 130. It should be noted that the order of the steps and the actual manner of operation of the present embodiment can be adjusted according to practical requirements, and are not limited to those in the present embodiment.

Step 110 is implementing a material selection step which includes: providing a polymer resin material 1 and an organic azo pigment 2.

The polymer resin material 1 is preferably at least one material selected from the group consisting of a polyester (PET) resin, a polyolefin (PE) resin, a polyacrylonitrile (PAN) resin, and a polyamide (PA) resin. The organic azo pigment 2 is formed by a diazo coupling reaction between a diazo component and a coupling component, and a molecular structure of the organic azo pigment 2 has a plurality of chromophores which include an azo group and a methyl amine group. The organic azo pigment 2 has an average particle size between 0.2 and 4 micrometers (preferably between 0.3 and 3 micrometers) and a heat-resistant temperature of not less than 300° C. (preferably not less than 350° C.). In addition, the organic azo pigment 2 has an infrared reflectance of not less than 50% in an infrared wavelength range between 780 nm and 2,500 nm.

Step 120 is implementing a masterbatch forming step which includes: melting and mixing the polymer resin material 1 from 50 to 99.5 weight percent with the organic azo pigment 2 from 0.5 to 50 weight percent under a temperature between 150° C. and 300° C. to form a mixture, and then cooling and solidifying the mixture to form a plurality of thermal-insulation masterbatches. In the masterbatch forming step, the organic azo pigment 2 can be dispersed in the polymer resin material 1 in the form of a plurality of micro particles by being blended.

Step 130 is implementing a fiber forming step which includes: melt-spinning the plurality of thermal-insulation masterbatches under the temperature between 150° C. and 300° C. to form a plurality of dark-colored and infrared-reflective fibers 100.

More specifically, in an embodiment of the present disclosure, if the content range of the organic azo pigment 2 in the thermal-insulation masterbatches is already in an appropriate content range, the thermal-insulation masterbatches can be directly melt-spun to form the plurality of dark-colored and infrared-reflective fibers 100.

In another embodiment of the present disclosure, if the content range of the organic azo pigment 2 in the thermal-insulation masterbatches is too high, the thermal-insulation masterbatches can be further mixed with additional pure polymer resin material in an appropriate ratio and then melt-spun together, so that the organic azo pigment 2 can have an appropriate content range in the dark-colored and infrared-reflective fibers 100.

Therefore, the dark-colored and infrared-reflective fiber 100 can achieve an ideal dark-color and thermal-insulation effect, and can also have the advantages of environmental protection and low toxicity, without adding any heavy metal composition and additional dark pigment.

According to the above configuration, an L value of the dark-colored and infrared-reflective fiber 100 in a CIELAB color space is preferably not greater than 15, and more preferably not greater than 12. That is, the dark-colored and infrared-reflective fiber 100 can achieve sufficient blackness.

It is worth mentioning that since the heat-resistant temperature of the organic azo pigment 2 is preferably not lower than 300° C., and more preferably not lower than 350° C., the organic azo pigment 2 will not severely crack during the preparation of the thermal-insulation masterbatches in step S120 and the melt-spinning process in step S130, so that the organic azo pigment 2 can maintain its original characteristics.

[Dark-Colored and Infrared-Reflective Textile]

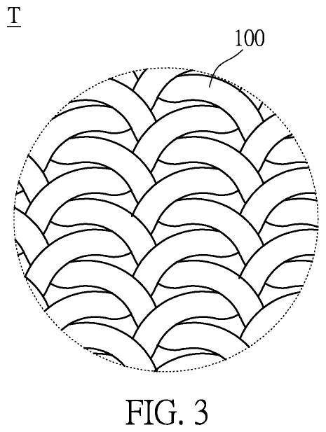

Referring to FIG. 3, the plurality of dark-colored and infrared-reflective fibers 100 can be interlaced and woven to form a dark-colored and infrared-reflective textile T.

The dark-colored and infrared-reflective textile T preferably has a thickness between 500 micrometers and 1,500 micrometers, and each of the dark-colored and infrared-reflective fibers 100 includes a polymer resin material 1 and an organic azo pigment 2 dispersed in the polymer resin material 1. The material selection and content range of the polymer resin material 1 and the organic azo pigment 2 have been described in detail in the above embodiments, and will not be reiterated herein.

### Experimental Test Result

In the following, the dark-colored and infrared-reflective textile of the present embodiment is tested for material properties such as infrared reflectance, thermal-insulation effect, and color.

In terms of comparative examples, a commercially available dark-colored and thermal-insulation textile and a carbon black-added textile are also tested under the same specifications, so as to compare the differences of the material properties of the dark-colored and infrared-reflective textile of the present embodiment with those of the comparative examples.

The commercially available dark-colored and thermal-insulation textile refers to the textile to which inorganic infrared reflective materials (i.e., inorganic heavy metal materials) and dark pigments (i.e., black pigments) are added. In addition, the carbon black-added textile refers to a textile that uses carbon black as the source for dark pigments without infrared reflective material.

The infrared reflectance test is: using a UV/Vis/NIR spectrometer (model Lambda 750, Perkin Elmer) to perform the infrared reflectance test at a wavelength of 780 nm to 2,500 nm on the dark-colored and infrared-reflective textile of the present embodiment, the commercially available dark-colored and thermal-insulation textile, and the carbon black-added textile, under the same cloth weight and cloth specification. More specifically, the infrared reflectance is measured in accordance with JIS R3106 of the Japanese Industrial Standards (JIS). The calculated wavelength range is from 780 nm to 2,500 nm, and more preferably from 780 nm to 2,100 nm. In terms of test results, the infrared reflectance of the dark-colored and infrared-reflective textile of the present embodiment is approximately 57% to 58%, the infrared reflectance of the commercially available dark-colored and thermal-insulation textile is approximately 52% to 53%, and the infrared reflectance of the carbon black-added textile is less than 10%. The test results of the above experimental data show that the dark-colored and infrared-reflective textile of the present embodiment has substantially the same or even slightly better infrared reflection effect than the commercially available dark-colored and thermal-insulation textile. In addition, the infrared reflection effect of the dark-colored and infrared-reflective textile of the present embodiment is obviously better than that of the carbon black-added textile. It is worth mentioning that the infrared reflectance of the organic azo pigment of the raw material of the present embodiment is approximately 65% to 70%, and the content of the organic azo pigment in the fiber is approximately 0.5 wt % to 20 wt %, so that the infrared reflectance of the textile of the present embodiment is approximately 57% to 58%.

The test of thermal-insulation effect is based on the nano Mark TN-037. The dark-colored and infrared-reflective textile of the present embodiment, the commercially available dark-colored and thermal-insulation textile, and the carbon black-added textile are tested using a light box tester to conduct textile insulation test. The test method is to simultaneously place two pieces of cloth samples (one of which is a standard cloth sample) with the same cloth weight and cloth specifications in the left and right semicircular tubes of the light box tester, respectively. The temperature of the standard cloth sample is controlled at 46° C.±2° C., and the same heat source (175 W infrared lamp) is irradiated on the two pieces of cloth samples for 10 minutes, and then the temperature variations of the cloth samples are observed and compared. In terms of test results, the temperature of the dark-colored and infrared-reflective textile of the present embodiment is approximately from 45.5° C. to 46.5° C. after heating. The temperature of the commercially available dark-colored and thermal-insulation textile is approximately 46.5° C. to 47.5° C. after heating. The temperature of the generally carbon black-added textile is approximately 54° C. to 55° C. after heating. The test results of the above experimental data show that the dark-colored and infrared-reflective textile of the present embodiment has substantially the same or even slightly better thermal-insulation effect than the commercially available dark-colored and thermal-insulation textile. In addition, the thermal-insulation effect of the dark-colored and infrared-reflective textile of the present embodiment is obviously better than that of the general carbon black-added textile.

The color test is performed by using a spectrophotometer (model X-rite Color-Eye 70000A) on the dark-colored and infrared-reflective textile of the present embodiment, the commercially available dark-colored and thermal-insulation textile, and the carbon black-added textile. Colors are described in the CIELAB color space proposed by the International Commission on Illumination (CIE), in which the L value refers to the lightness of the color (black is 0 and white is 100), and an a value is a green-red value between green and red (green is negative and red is positive), and a b value is a blue-yellow value between blue and yellow (blue is negative and yellow is positive). In terms of test results, the (L value, a value, and b value) of the dark-colored and infrared-reflective textile of the present embodiment are (11.5, 0.61, 1.01), respectively. The (L value, a value, and b value) of the commercially available dark-colored and thermal-insulation textile are (16.1, −0.17, −0.40), respectively. The (L value, a value, and b value) of the general carbon black-added textile are (13.0, 0.15, 0.27), respectively. The test results of the above experimental data show that the dark-colored and infrared-reflective textile of the present embodiment has relatively excellent blackness (L value is relatively low) than that of the commercially available dark-colored and thermal-insulation textile and the general carbon black-added textile.

TABLE 1
Experimental test results

| | infrared | thermal-insulation | |
|---|---|---|---|
| items | reflectance | effect | color |
| dark-colored and | between | between | L value |
| infrared-reflective | 57% and 58% | 45.5° C. and 46.5° C. | 11.5 |
| textile of the | | after heating | |
| present embodiment | | | |
| commercially available | between | between | L value |
| dark-colored and | 52% and 53% | 46.5° C. and 47.5° C. | 16.1 |
| thermal-insulation | | after heating | |
| textile | | | |
| general carbon | less than | between | L value |
| black-added items | infrared | thermal-insulation | color |
| | reflectance | effect | |
| textile | 10% | 54° C. and 55° C. | 13.0 |
| | | after heating | |

According to the above test results, the commercially available dark-colored and thermal-insulation textile has a certain thermal-insulation effect and blackness. However, the commercially available dark-colored and thermal-insulation textile needs to be added with inorganic infrared reflective materials (i.e., inorganic heavy metal materials) and other dark pigments (i.e., black pigments) to achieve sufficient blackness.

Compared to the commercially available dark-colored and thermal-insulation textile, the dark-colored and infrared-reflective fiber of the present embodiment can achieve ideal dark-colored and thermal-insulation effects, and can also have the advantages of environmental protection and low toxicity, without adding any heavy metal material and additional dark pigment.

### Advantageous Effects

The dark-colored and infrared-reflective fiber without metal composition, the manufacturing method thereof and the textile of the present embodiment can achieve an ideal dark-color and thermal-insulation effect, and can also have the advantages of environmental protection and low toxicity, without adding any heavy metal composition and additional dark pigment, through the technical features of “an organic azo pigment is formed by a diazo coupling reaction between a diazo component and a coupling component, and the organic azo pigment is dispersed in the polymer resin material in the form of a plurality of micro particles” and “the organic azo pigment has an average particle size between 0.2 micrometers and 4 micrometers and a heat-resistant temperature of not less than 300° C.; and the organic azo pigment has an infrared reflectance of not less than 50% in an infrared wavelength range between 780 nm and 2,500 nm”.

Moreover, since the dark-colored and infrared-reflective textile of the present embodiment has an ideal thermal-insulation effect, the temperature rise of the textile under sunlight can be effectively reduced. Therefore, when the dark-colored and infrared-reflective textile is made into a cloth and worn by a user, the user will not feel stifled when under sunlight.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A dark-colored and infrared-reflective fiber without metal composition, characterized in that the fiber is formed by melt spinning, and the fiber comprises:
a polymer resin material; and
an organic azo pigment formed by a diazo coupling reaction between a diazo component and a coupling component, and the organic azo pigment being dispersed in the polymer resin material in the form of a plurality of micro particles;
wherein the organic azo pigment has an average particle size between 0.2 micrometers and 4 micrometers and a heat-resistant temperature of not less than 300° C.; wherein the organic azo pigment has an infrared reflectance of not less than 50% in an infrared wavelength range between 780 nm and 2,500 nm.

2. The dark-colored and infrared-reflective fiber according to claim 1, wherein a molecular structure of the organic azo pigment has a plurality of chromophores which include an azo group and a methyl amine group.

3. The dark-colored and infrared-reflective fiber according to claim 2, wherein the polymer resin material is a material being at least one selected from the group consisting of a polyester resin, a polyolefin resin, a polyacrylonitrile resin, and a polyamide resin.

4. The dark-colored and infrared-reflective fiber according to claim 2, wherein based on the total weight of the fiber, a content range of the polymer resin material is between 80 wt % and 99.5 wt %, and a content range of the organic azo pigment is between 0.5 wt % and 20 wt %, so that an L value of the fiber in a CIELAB color space is not greater than 15.

5. The dark-colored and infrared-reflective fiber according to claim 2, wherein the fiber does not include any chromium (Cr), manganese (Mn), iron (Fe), cobalt (Co), nickel (Ni), copper (Cu), zinc (Zn), silver (Ag), cadmium (Cd), gold (Au) or bismuth (Bi), and the fiber does not include any compatibilizer.

6. The dark-colored and infrared-reflective fiber according to claim 2, further comprising an antioxidant, wherein based on the total weight of the fiber, a content range of the antioxidant is between 0.1 wt % and 1 wt %.

7. A manufacturing method of a dark-colored and infrared-reflective fiber, comprising:
implementing a masterbatch forming step which includes: mixing a polymer resin material from 50 to 99.5 weight percent with an organic azo pigment from 0.5 to 50 weight percent under a temperature between 150° C. and 300° C. to form a plurality of thermal-insulation masterbatches; and
implementing a fiber forming step which includes: melt-spinning the plurality of thermal-insulation masterbatches under a temperature between 150° C. and 300° C. to form a plurality of dark-colored and infrared-reflective fibers;
wherein the organic azo pigment is formed by a diazo coupling reaction between a diazo component and a coupling component, and the organic azo pigment is dispersed in the polymer resin material in the form of a plurality of micro particles;
wherein the organic azo pigment has an average particle size between 0.2 micrometers and 4 micrometers and a heat-resistant temperature of not less than 300° C., and the organic azo pigment has an infrared reflectance of not less than 50% in an infrared wavelength range between 780 nm and 2,500 nm;
wherein an L value of each of the fibers in a CIELAB color space is not greater than 15.

8. The manufacturing method of the dark-colored and infrared-reflective fiber according to claim 7, wherein a molecular structure of the organic azo pigment has a plurality of chromophores which include an azo group and a methyl amine group.

9. The manufacturing method of the dark-colored and infrared-reflective fiber according to claim 8, wherein the polymer resin material is a material being at least one selected from the group consisting of a polyester resin, a polyolefin resin, a polyacrylonitrile resin, and a polyamide resin.

10. A textile characterized in that the textile is formed by interlacing a plurality of dark-colored and infrared-reflective fibers, the textile has a thickness between 500 micrometers and 1,500 micrometers, and each of the dark-colored and infrared-reflective fibers comprises:
a polymer resin material; and
an organic azo pigment formed by a diazo coupling reaction between a diazo component and a coupling component, the organic azo pigment being dispersed in the polymer resin material in the form of a plurality of micro particles;
wherein the organic azo pigment has an average particle size between 0.2 micrometers and 4 micrometers and a heat-resistant temperature of not less than 300° C.; wherein the organic azo pigment has an infrared reflectance of not less than 50% in an infrared wavelength range between 780 nm and 2,500 nm.
